(19) United States
(12) Patent Application Publication
(10) Pub. No.: US 2026/0067472 A1
(43) Pub. Date: Mar. 5, 2026

(54) OPTIMIZED VIDEO PROCESSING THROUGH SOURCE-SIDE TAGGING FOR GENERATIVE ARTIFICIAL INTELLIGENCE SYSTEMS

(71) Applicant: NVIDIA Corporation, Santa Clara, CA (US)

(72) Inventors: Shaunak Gupte, Dombivli (IN); Bhushan Rupde, Pune (IN)

(73) Assignee: NVIDIA Corporation, Santa Clara, CA (US)

(21) Appl. No.: 18/825,277

(22) Filed: Sep. 5, 2024

(51) Int. Cl. H04N 19/184; H04N 19/139; H04N 19/70

(52) U.S. Cl. CPC H04N 19/184; H04N 19/139; H04N 19/70

(57) ABSTRACT

In various examples, systems and methods are disclosed relating to generating video streams for generative artificial intelligence models. A system can receive a plurality of frames from a capture device capturing a video stream. The system can determine that at least one frame of the plurality of frames is to be provided as input to a machine-learning model. The system can generate an indication that the at least one frame is to be provided as input to the machine-learning model. The system can generate an encoded bitstream for the video stream. The encoded bitstream can include encoded data for the plurality of frames and the indication.

### BACKGROUND

Video language models (VLMs) are machine learning models that integrate video analysis with natural language understanding and generation. VLMs are trained/updated to interpret video content and generate corresponding output, which may include text descriptions or other generative content. However, existing solutions for executing VLMs require significant and specialized computer hardware or fail to capture all relevant information in video data.

### SUMMARY

Video language models can be trained/updated using large corpuses of video information. When providing video data as input to video language models, processing the entirety of a video is impractical because videos often include 24 to 60 frames per second. Processing every frame directly leads to high computational and memory demands that cannot be satisfied in most use cases. To circumvent these limitations, frames of an input video are sampled from a video stream to reduce the amount of data that is to be processed by the VLM during execution. In conventional video language model platforms, sampling is performed such that one frame is selected according to a predetermined time interval. However, as conventional approaches do not consider the content of the frame(s) selected, the video language model may not be exposed to un-sampled frames that include relevant or important information for a given processing objective.

To address the limitations of conventional approaches, the systems and methods described herein implement tagging/marking of video data as it is captured, using local event detection functions implemented on the device capturing a video stream. Frames of the video stream can be automatically tagged/marked when those frames are determined to have attributes that satisfy one or more thresholds or conditions, such as motion detected in the frame (e.g., based on motion vectors from the video encoder or from an optical flow system), detected objects in the frame (e.g., based on the output of lightweight object detection models), or temporal activity detected in the frame, among others.

The marked/tagged frames can be decoded and provided as input to a VLM for processing. These approaches enable selectively providing frames as input to VLMs based on their content, rather than periodically providing frames that may not include relevant information. Further, these techniques avoid costly processing operations, such as processing the entire video stream at once to identify relevant frames during the machine-learning operation(s), by instead tagging/marking relevant frames at the device capturing the video stream. The techniques described herein therefore improve upon conventional approaches for executing machine-learning models by reducing the amount of computational resources required to process relevant frames of video data.

At least one aspect relates to one or more processors. The one or more processors can include one or more circuits. The one or more circuits can receive a plurality of frames from a capture device capturing a video stream. The one or more circuits can determine that at least one frame of the plurality of frames is to be provided as input to a machine-learning model. The one or more circuits can generate an indication that the at least one frame is to be provided as input to the machine-learning model. The one or more circuits can generate an encoded bitstream for the video stream, the encoded bitstream including encoded data for the plurality of frames and the indication.

In some implementations, the one or more circuits can determine that the at least one frame is to be provided as input to the machine-learning model based at least on a motion vector of the at least one frame. In some implementations, the motion vector is generated by an encoding process or an optical flow process. In some implementations, the one or more circuits can determine, using a second machine-learning model, that the at least one frame depicts an object of interest. In some implementations, the one or more circuits can determine that the at least one frame is to be provided as input to the machine-learning model responsive to determining that the at least one frame depicts the object of interest.

In some implementations, the one or more circuits can generate the indication to include a binary value indicating that the at least one frame is to be provided as input to the machine-learning model. In some implementations, the one or more circuits can generate the indication to include supplemental enhancement information (SEI) indicating that the at least one frame is to be provided as input to the machine-learning model. In some implementations, the SEI information includes an indication of at least one object detected in the frame. In some implementations, the one or more circuits can transmit the encoded bitstream to a receiver system, causing the receiver system to decode the encoded bitstream and provide the at least one frame as input to the machine-learning model. In some implementations, the one or more circuits can transmit the encoded bitstream according to a real time streaming protocol (RTSP).

At least one aspect relates to a system. The system can include one or more processors. The system can receive an encoded bitstream of a video stream. The system can decode the encoded bitstream to obtain a plurality of frames and an indication that at least one frame of the plurality of frames is to be provided as input to a machine-learning model. The system can provide the at least one frame as input to the machine-learning model according to the indication.

In some implementations, the system can retrieve the encoded bitstream of the video stream from a database. In some implementations, the system can generate metadata by decoding the encoded bitstream, the metadata comprising the indication that the at least one frame is to be provided as input to the machine-learning model. In some implementations, the system can update the machine-learning model using the at least one frame. In some implementations, the machine-learning model comprises a video language model.

At least one aspect is related to a method. The method can include receiving, using one or more processors, a plurality of frames from a capture device capturing a video stream. The method can include determining that at least one frame of the plurality of frames includes at least one attribute that satisfies one or more thresholds. The method can include, in response to the determination, generating an indication for the at least one frame. The method can include generating an encoded bitstream for the video stream, the encoded bitstream including encoded data for the plurality of frames and the indication.

In some implementations, the at least one attribute includes at least one of a motion vector detected in the at least one frame, an object detected in the at least one frame, or a temporal activity detected in the at least one frame. In some implementations, the motion vector is generated by an encoding process or an optical flow process. In some implementations, the method can include determining, using a second machine-learning model, that the at least one frame depicts an object of interest. In some implementations, the method can include determining that the at least one frame is to be provided as input to the machine-learning model responsive to determining that the at least one frame depicts the object of interest.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a large language model, a system for performing generative AI operations using a video language model, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for implementing optimized video processing through source-side tagging for generative artificial intelligence systems are described in detail below with reference to the attached drawing figures, wherein:

FIG. 1 is a block diagram of an example system for implementing video stream generation for generative artificial intelligence systems, in accordance with some embodiments of the present disclosure;

FIG. 2 depicts a dataflow diagram showing how frames are sampled for training/updating machine-learning models, in accordance with some embodiments of the present disclosure;

FIG. 3 is a flow diagram of an example of a method for implementing optimized video processing through source-side tagging, in accordance with some embodiments of the present disclosure;

FIG. 4A is a block diagram of an example generative LLM system suitable for use in implementing some embodiments of the present disclosure;

FIG. 4B is a block diagram of an example generative LLM that includes a transformer encoder-decoder suitable for use in implementing some embodiments of the present disclosure;

FIG. 4C is a block diagram of an example generative LLM that includes a decoder-only transformer architecture suitable for use in implementing some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

This disclosure relates to systems and methods for generating video streams for use in generative artificial intelligence (AI) systems, including generative AI systems that implement language models (e.g., video language models (VLMs), etc.). The techniques described herein can be used to enable efficient, real-time capture of video streams that are optimized for processing by machine-learning systems. Such approaches may be implemented in systems that capture and provide video streams for provision to generative machine-learning models, including capture devices such as smartphones, tablets, edge devices, network-enabled cameras or capture devices, surveillance cameras/capture devices, and automotive capture devices, among others.

Conventional machine-learning systems cannot process the entirety of video streams, as it is computationally impracticable to separately process each frame in the video stream, which may exceed 24 to 30 frames per second. Instead, typical systems filter the input video stream and only selectively provide certain frames to the machine-learning model to reduce the computational resources required. However, these approaches only implement periodic sampling of frames, such that only one of every predetermined number of frames (e.g., one out of every hundred, etc.) are selected for processing using the machine-learning model. As a result, important information represented in unselected frames are not processed by the model, causing the machine-learning model to miss critical details that occur in the video stream.

To address the limitations of conventional machine-learning systems, the techniques described herein can implement tagging/marking of video data as it is captured, using local event detection functions implemented on the device capturing the video stream. These approaches enable the device capturing a video stream to automatically tag/mark any frame determined to have attributes that satisfy one or more thresholds or conditions, such as motion detected in the frame (e.g., based on motion vectors from the video encoder or from an optical flow system), detected objects in the frame (e.g., based on the output of lightweight object detection models), or temporal activity detected in the frame, among others.

The device can then generate an encoded bitstream that includes the tags/markers indicating which frames that are to be provided as input to a machine-learning system. Tags/markers added to the frame can be encoded as part of the bitstream, and may be provided, in some implementations, as a binary value or as supplemental enhancement information (SEI). SEI data included in the bitstream may include encoded text data or other metadata that indicates information about the conditions that caused the corresponding frames to be tagged/marked.

A receiver system can decode the encoded bitstream and can extract the tags/markers indicating which frames are to be provided as input to the machine-learning model. In one example, the receiver system can provide the marked/tagged frames to an embeddings layer of a VLM for processing. In some implementations, the receiver system can further filter the tagged/marked frames to satisfy the available computational resources for executing the VLM. These approaches enable selectively providing frames as input to machine-learning models based on their content, rather than periodically providing frames that may not include relevant information. Further, these techniques avoid costly processing operations at the receiver system (e.g., processing of the entire video stream at once to identify relevant frames) by implementing tagging/marking of relevant frames at the device capturing the video stream.

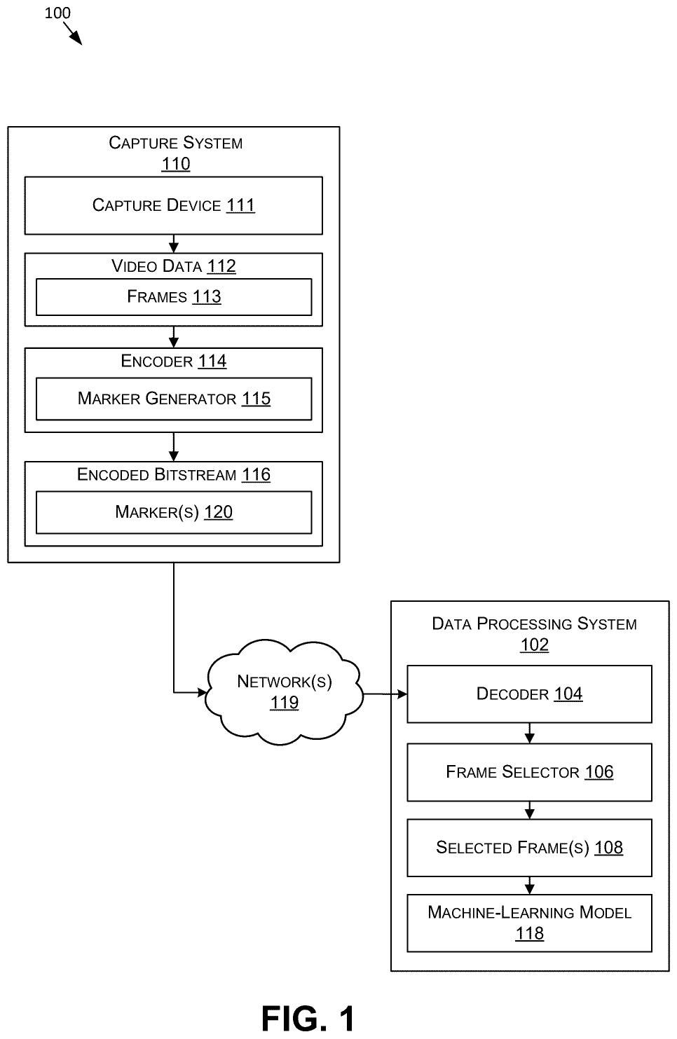

With reference to FIG. 1, FIG. 1 is an example computing environment including a system for implementing video stream generation for generative artificial intelligence systems, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 can be utilized to generate tags (e.g., marker(s) 120) for frames of video data 112 that are classified as relevant or potentially relevant for processing using a machine-learning model 118. The system 100 is shown as including a capture system 110, a data processing system 102, and one or more networks 119. The capture system 110 is shown as including a capture device 111 that can generate video data 112 and can implement an encoder process 114 (sometimes referred to herein as an “encoder 114”) that generates an encoded bitstream 116 from the video data 112. A marker generator process 115 (sometimes referred to as a “marker generator 115”) can be used to identify which frames are to be processed using machine-learning model(s) described herein. The data processing system 102 is shown as implementing a decoder process 104 (sometimes referred to herein as a “decoder 104”), a frame selector process 106 (sometimes referred to herein as a “frame selector 106”) that identifies selected frame(s) 108 to provide as input to a machine-learning model 118.

The capture system 110 can include any type of computing device that includes or is in communication with a capture device 111 that can capture video data 112. The capture system 110 may include, but is not limited to, a smartphone device, a tablet device, a laptop, a personal computer, a server, a distributed computing environment, a network-enabled camera device, or a surveillance camera device, among others. The capture system 110 is shown as being in communication with the network 119, and can transmit data (e.g., the encoded bitstream 116) to the data processing system 102 or one or more external systems for processing and/or storage.

The capture system 110 is shown as including one or more capture devices 111. A capture device 111 can include, but is not limited to, a digital video camera, a webcam, a smartphone camera, a surveillance camera, a vehicle-mounted camera, or another type of device that is capable of capturing sequences of images and/or video frames. The capture device 111 can be implemented using hardware or a combination of software and hardware. The capture device 111 can capture any type of video data 112, including color (e.g., red-green blue (RGB) video data), grayscale, or infrared video data.

The capture system 110 can capture video data 112 in response to input from an operator of the capture system 110 or in response to a signal received via the network 119. In some implementations, the video data 112 may be provided as part of a live video stream. In some implementations, the capture system 110 can capture and store recorded video data 112 that is subsequently transmitted to the data processing system 102 or an external system for storage and/or process. The video data 112 can include standard definition video, high-definition video, 4K video, or other types of video content. The video data 112 may include a predetermined or dynamic frame rate. For example, the video data 112 captured by the capture device 111 can have a frame rate of 24 frames-per-second, 30 frames-per-second, or 60 frames-per-second. The video data 112 can include color video data, grayscale video data, or other types of video data such as like thermal imaging video, or three-dimensional video (e.g., RGB-D video data).

In some implementations, the video data 112 can be generated by one or more applications executed by the capture system. For example, the video data 112 may be generated from frames 113 produced by a video game application. The video data 112 may also be generated by other types of applications, such as remote desktop or remote access applications executing on the capture system 110. In such implementations, the frames 113 may be generated by one or more rendering processes executed by the capture system 110, which render frames 113 that depict, for example, three-dimensional environments, application interfaces, or other graphical information that may be generated by an application executing on the capture system 110.

Video data 112 captured or generated by the capture system 110 can be processed by the encoder 114 to generate an encoded bitstream 116. The encoder 114 of the capture system 110 can encode the video data 112 into a suitable format for transmission by generating an encoded bitstream 116 according to one or more codec standards. Encoding the video data 112 reduces the overall amount of information that is to be transmitted to the data processing system 102 or other external system for subsequent processing and/or storage. The encoder 114 may utilize any combination of hardware or software to encode the video data 112. Encoding the video data 112 can include converting the video data 112 to conform to any suitable video codec standard, including but not limited to an AVC (or h.264), HEVC (or h.265), VVC (or h.266), VP8, VP9, or AV1, or any other video codec standard. Similar codec standards may be utilized to encode audio data.

The encoder 114 can generate the encoded bitstream 116 continuously, for example, as frames are captured by the capture device 111 or generated from an application or source of the video data 112. The encoder 114 may generate the encoded bitstream to include a chronological sequence of encoded video frames. In some implementations, the encoder 114 can generate the encoded bitstream 116 subsequent to capturing and storing the video data 112 in memory of the capture system 110. In some implementations, the encoder 114 can generate the encoded bitstream 116 as a video file that is stored in memory of the capture system 110. The video file may be transmitted via the network 119 to one or more external systems (e.g., the data processing system 102) for subsequent processing and/or storage.

In some implementations, the encoder 114 can generate the encoded bitstream 116 to be transmitted as part of a video stream, for example, using via a streaming protocol such as the real-time transport protocol (RTP). When transmitting streaming video via a streaming protocol, individual video frames may be transmitted via the network 119 in sequences of one or more network packets, with each packet including one or more regions (e.g., slices, tiles, contiguous sequence(s) of macroblocks, any other logical sub-unit of a video frame 113 that may be encoded as a distinct part of the encoded bitstream 116) of the video frame 113. In such implementations, the encoded bitstream 116 may be provided as part of a video streaming application, including but not limited to a recorded live stream, a game stream, or a remote desktop session, among others.

The encoder process 114 can include or may be in communication with a marker generator process 115 (sometimes referred to as the “marker generator 115”) of the capture system 110. Although the marker generator 115 is shown as a part of the encoder 114, it should be understood that, in some implementations, the marker generator 115 may be separate from the encoder 114. The marker generator 115 can include hardware, software, or combinations of hardware and software that access frames 113 of the video data 112 to determine whether any frames 113 are to be provided as input to the machine-learning model 118, as described in further detail herein. The marker generator 115 can process the frame(s) 113 of the video data 112 continuously, for example, as the frames 113 are captured by the capture device 111 or generated from an application or source of the video data 112 (e.g., executing on the capture system 110 or from another external system in communication with the capture system via the network 119). The marker generator 115 may generate markers 120 to be included or stored in association with the encoded bitstream 116. As described in further detail herein, the markers 120 can be used to indicate which frames are to be provided as input to the machine-learning model 118 (or are to be subject to other processing operations, in some implementations).

Markers 120 can be generated by the marker generator 115 for each frame 113 that is determined to satisfy one or more marking conditions. In one example, a marker 120 can be generated for a frame 113 upon the marker generator 115 determining that the frame 113 indicates motion that exceeds a predetermined threshold. Motion in a frame 113 may be determined, for example, using one or more encoder motion vectors generated by the encoder 114. For example, the encoder 114 can generate one or more encoder motion vectors when encoding sequences of frames 113 of the video data 112. The encoding process can be performed on a frame-by-frame basis and can use information from a previous frame 113 to estimate motion between frames. For example, the encoder 114 can analyze a current frame 113 to identify blocks of pixels that have moved from their positions relative to the previous frame 113. The encoder 114 can calculate the direction and magnitude of this movement to generate one or more motion vectors. The generated motion vectors can be associated with the corresponding frame 113 in which the motion is detected.

Motion vectors generated by the encoder 114 when encoding the video data 112 can be provided to the marker generator 115. The marker generator 115 can compare encoder motion vectors generated by the encoder 114 to one or more motion thresholds to determine whether a marker 120 is to be generated for the corresponding frame 113. In some implementations, if the magnitude of one or more motion vectors exceeds the motion threshold(s), the marker generator 115 can generate at least one marker 120 for the corresponding frame 113 in which the motion is depicted. In some implementations, the generated marker 120 can include an indication of the condition that caused the marker to be generated, which in this example includes a motion vector that exceeds a motion threshold. The motion threshold(s) may be stored as configuration settings of the capture system 110 and may be modified via input to the capture system 110 or via one or more configuration messages received via the network 119, in some implementations.

In another example, the marker generator 115 can generate a marker 120 for a frame using one or more optical flow motion vectors. Optical flow motion vectors may be generated by one or more optical flow processes executing on the capture system 110. Optical flow processes may include hardware, software, or combinations of hardware and software that automatically generate data from frames captured using the capture device 111 of the capture system 110. Data generated via optical flow processes may be accessible via one or more application programming interfaces (APIs) of the capture system 110 or one or more operating system(s) executing thereon. If the capture system 110 includes optical flow processes/hardware, the marker generator 115 can access the APIs of the optical flow processes/hardware to retrieve one or more motion vectors generated by the optical flow processes/hardware (sometimes referred to herein as “optical flow motion vector(s)”).

The optical flow system(s) of the capture system 110 can process frame(s) 113 of the video data 112 as they are captured by the capture device 111 or generated by an application executing on the capture system 110, in some implementations. The optical flow systems may implement different processes for generating motion vectors that correspond to features, objects, pixels, or regions of frames 113 of the video data. In some implementations, the optical flow system(s) can generate a motion vector or motion vector field for a frame 113 that indicates motion relative to one or more previous frame(s) 113. The motion vectors can be generated by the optical flow system(s) using any suitable technique, including but not limited to gradient-based methods (e.g., Horn-Schunck-based motion functions), feature-based methods (e.g., Lucas-Kanade-based motion functions), energy-based methods, or other types of motion estimation functions (e.g., phase correlation, template matching, etc.).

The marker generator 115 can compare optical flow motion vectors generated by the optical flow system(s) of the capture system 110 to one or more motion thresholds to determine whether a marker 120 is to be generated for the corresponding frame 113. In some implementations, if the magnitude of one or more motion vectors exceeds the optical flow motion threshold(s), the marker generator 115 can generate at least one marker 120 for the corresponding frame 113 in which the motion is depicted. In some implementations, the generated marker 120 can include an indication of the condition that caused the marker to be generated, which in this example includes an optical flow motion vector that exceeds an optical flow motion threshold. The optical flow motion threshold(s) may be stored as configuration settings of the capture system 110 and may be modified via input to the capture system 110 or via one or more configuration messages received via the network 119, in some implementations.

The marker generator 115 can, in some implementations, execute one or more machine-learning models to determine whether to generate a marker 120 for a frame of video data. The machine-learning models may be stored in memory of the capture system 110 and may include models trained/updated to detect objects depicted in one or more frames 113 of the video data 112. The machine-learning models can be light-weight machine-learning models that may be executed in real-time or near real-time, as the video data 112 is captured or otherwise generated by the capture system 110. The machine-learning models of the marker generator 115 can include, but are not limited to, a convolutional neural network (CNN), a recurrent neural network (RNN), a long short-term memory (LSTM) network, or other types of machine-learning models.

The marker generator 115 can use the machine-learning models to determine whether to generate a marker 120 for a frame 113. In some implementations, the marker generator 115 can generate a marker 120 for a frame 113 if the frame 113 depicts one or more predetermined objects. The objects can be identified from the frame 113 using the machine-learning model(s) of the marker generator 115. To do so, the marker generator 115 can provide the frame 113 as input to the machine-learning model(s) and can execute the machine-learning model(s) to generate output identifying whether a marker 120 is to be generated for the frame.

In some implementations, the machine-learning model(s) of the marker generator 115 can include one or more object detection models that are trained/updated to classify whether any predetermined objects, such as people, faces, or objects of interest are depicted in an input frame 113. In some implementations, the machine-learning model(s) of the marker generator 115 can include one or more feature detection models that are trained/updated to classify whether any predetermined features are present in an input frame 113. Such features may include any attribute or aspect of the content depicted in the frame 113, including but not limited to indications that the frame 113 depicts a particular location, type of weather, or any other type of feature.

Additional techniques may be implemented in addition to the use of machine-learning models to detect objects or features of interest. For example, the marker generator 115 can implement one or more image processing techniques prior to providing the frame(s) 113 as input to the machine-learning model(s). In one example, background subtraction may be applied to the frame(s) 113. In some implementations, denoising approaches may be used to remove noise from frames 113 prior to executing one or more machine-learning models. In another example, change detection functions may be executed to estimate the difference(s) between sequential frames, which may flag certain frames 113 to be provided as input to the machine-learning model(s) of the marker generator 115. Such change detection functions may include, but are not limited to image differencing, change vector analysis, or statistical hypothesis testing, among others.

The machine-learning models of the marker generator 115 can be executed to generate one or more indications of whether objects or features of interest are depicted in an input frame 113. If the output indicates that one or more objects or features of interest are depicted in a frame 113, the marker generator 115 can generate a marker 120 corresponding to the object or feature detected in the frame 113. In some implementations, the generated marker 120 can include an indication of the condition that caused the marker to be generated, which in this example may include an indication that the frame depicts an object or feature of interest and/or the classification of the object or feature of interest.

In some implementations, the marker generator 115 can generate markers 120 for frames 113 that indicate temporal activity. Temporal activity can be any type of activity that is detected from a sequence of frames 113 in the video data (e.g., generated over time). Such temporal activity may include classifications of certain types of motion (e.g., whether a person is walking, running, etc.), changes in speeds of different objects detected in frames over time (e.g., whether a vehicle is accelerating or decelerating), or any other type of activity that can be classified over multiple frames 113 of the video data 112.

Temporal activity may be detected, for example, using one or more machine-learning models (e.g., CNN models or RNN models) that are trained/updated to classify the presence of temporal activity. If the output of such machine-learning models indicate that temporal activity of interest is depicted in a frame 113, the marker generator 115 can generate a marker 120 corresponding to the temporal activity of interest detected in the frame 113. As temporal activity is detected from sequences of frames 113, the marker 120 can be generated for the first frame in which temporal activity was detected. In some implementations, the marker 120 can be generated for the last frame in which the temporal activity was detected, or for both the first and last frames, in some implementations. The generated marker 120 may include an indication of the condition that caused the marker to be generated, which in this example may include an indication that the frame 113 depicts a temporal activity of interest and/or the classification of the temporal activity of interest.

In some implementations, the marker generator 115 can generate markers 120 for frames 113 in a manner that limits the total number of frames 113 that are to be provided as input to the machine-learning model 118. For example, once a marker 120 has been generated for a frame 113, the marker generator 115 may cease generating additional markers 120 for a predetermined number of frames 113. Doing so can limit the number of frames that are marked for provision to the machine-learning model 118, to reduce the processing requirements of executing the machine-learning model 118 using the video data 112.

In some implementations, even when limiting the number of markers 120 generated for the frames 113 of the video data 112, the marker generator 115 can generate markers 120 in response to detecting high priority conditions. For example, a configuration setting of the capture system 110 can indicate that certain objects, temporal activities, or features depicted in a frame 113 may always warrant generation of a marker 120, even when the aforementioned limitations (e.g., generating markers 120 once every predetermined number of frames 113) are implemented. Doing so enables frames 113 with particularly relevant data for the machine-learning model 118 to be provided as input to the machine-learning model 118 to maximize accuracy. In some implementations, the marker generator 115 can generate markers 120 for all frames 113 that satisfy a condition (e.g., a detected object, feature, temporal activity, etc.).

The markers 120 generated by the marker generator 115 can be included as part of the encoded bitstream 116, as shown. In some implementations, a marker 120 can be a single bit, byte, or data structure assigned to a corresponding encoded frame in the encoded bitstream 116. In some implementations, the markers 120 may be provided as part of Supplemental Enhancement Information (SEI) included in the encoded bitstream 116. In such implementations, the SEI information may be or include metadata relating to the video data 112 and/or the encoded bitstream 116. The markers 120 provided in the SEI data can include indications of which frames 113 of the video data 112 are to be provided as input to the machine-learning model 118, and in some implementations, additional information relating to the condition(s) that caused generation of the corresponding marker(s) 120, as described herein.

The capture system 110 can transmit the generated encoded bitstream 116 (including any marker(s) 120) to the data processing system 102 via the network 119. The network 119 can include computer networks such as the Internet, local, wide, metro, or other area networks, intranets, satellite networks, other computer networks such as voice or data mobile phone communication networks, and combinations thereof. The network 119 may be any form of computer network that can relay information between the capture system 110, the data processing system 102, and one or more external systems, amongst others. In some implementations, the network 119 may include the Internet and/or other types of data networks, such as a local area network (LAN), a wide area network (WAN), a cellular network, a satellite network, or other types of data networks. The network 119 may also include any number of computing devices (e.g., computers, servers, routers, network switches, etc.) that are configured to receive and/or transmit data within the network 119. The network 119 may further include any number of hardwired and/or wireless connections. Any or all of the computing devices described herein may communicate wirelessly (e.g., via WiFi, cellular, radio, etc.) with a transceiver that is hardwired (e.g., via a fiber optic cable, a CAT6 cable, etc.) with other computing devices in the network 119. Any or all of the computing devices described herein may also communicate wirelessly with the computing devices of the network 119 via a proxy device (e.g., a router, network switch, or gateway).

The capture system 110 can transmit the encoded bitstream 116, including any generated markers 120, in one or more network packets to the data processing system 102. In some implementations, the capture system 110 can transmit the encoded bitstream 116 and marker(s) 120 to a storage system separate from and accessible by the data processing system 102. The encoded bitstream 116 and marker(s) 120 may be transmitted in real-time or near real-time, for example, as the encoded bitstream 116 and marker(s) 120 are generated. In some implementations, the encoded bitstream 116 and marker(s) 120 can be transmitted or otherwise provided via the network 119 subsequent to capturing and encoding the video data 112. For example, the encoded bitstream 116 and marker(s) 120 can be transmitted via the network 119 in response to operator input at the capture system 110, in some implementations.

The system 100 is shown as including a data processing system 102. The data processing system 102 can include one or more processors, circuits, memory, and/or computing devices/systems that can perform the various techniques described herein. The data processing system 102 can be implemented, for example, in a cloud computing environment, which may maintain, update, and/or execute one or more machine-learning models 118. The data processing system 102 can implement the various techniques described herein to selectively provide decoded frames (e.g., the selected frame(s) 108) as input to the machine-learning model 118, which may include a video language model.

As shown, the data processing system 102 can maintain, execute, and train/update one or more machine-learning models 118. In some implementations, the machine-learning model(s) 118 can include any type of multimodal machine-learning model capable of processing video data. For example, the machine-learning model(s) 118 can be trained/updated to process natural language text input, audio input, video input, or image input, among other media modalities. In some implementations, the machine learning model(s) 118 may be or include a language model for multimodal tasks (LMMs). The machine-learning model(s) 118 may be or include a transformer-based model (e.g., a generative pre-trained transformer (GPT) model). The machine-learning model(s) 118 may be or include a VLM, in some implementations. In some implementations, the machine-learning model(s) 118 may include one or more tokenizer models, which are capable of converting media data into an encoded format (e.g., one or more tokens, or a “tokenized” format) that is compatible with the layers of the machine-learning model(s) 118.

The data processing system 102 can execute the machine-learning model 118 to generate output. The data processing system 102 can receive data to provide as input to the machine-learning model(s) 118, which may include text data, audio data, video data, image data, or combinations thereof. To efficiently transmit video information, the data processing system 102 can receive encoded video information (e.g., the encoded bitstream 116) to provide as input to the machine-learning model 118. In some implementations, the data processing system 102 can receive an identifier of encoded video data, which may indicate a network storage location for a corresponding encoded bitstream 116. The data processing system 102 can use the identifier to retrieve (e.g., from an external system) the encoded bitstream 116 for processing using the machine-learning model 118, as described herein.

In some implementations, the data processing system 102 can receive input data for the machine-learning model 118 from the capture system 110 via the network 119, which may include video data and/or text data. For example, an operator of the capture system 110 can provide input text data via one or more input devices (e.g., keyboard, touchscreen, etc.) of the capture system 110. The capture system 110 can capture and provide encoded bitstreams 116 that include one or more markers 120 to the data processing system 102 for processing, as described herein. In some implementations, the encoded bitstream 116 may be provided with text data (e.g., a text input prompt) for the machine-learning model 118, among other types of multimedia data.

Upon receiving the input data for the machine-learning model 118, the data processing system 102 can convert the input data into a format (e.g., a numerical representation, etc.) that is compatible with the input layers of the machine-learning model 118. To efficiently process the encoded bitstream 116, the data processing system 102 can execute a decoder 104. The decoder 104 can include software, hardware, or combinations of hardware and software that can decode encoded video information according to one or more codecs. Furthering the above example, the decoder 104 can decode the encoded bitstream 116 to reconstruct the frames 113 making up the raw video data 112. To do so, the decoder 104 can parse the encoded bitstream to extract any associated video metadata, including the codec or encoding algorithm used to generate the encoded bitstream 116. The decoder 104 can execute a corresponding decoding algorithm that implements the inverse of the encoding processes used to generate the encoded bitstream 116.

When decoding the encoded bitstream 116, the decoder 104 can extract the markers 120 generated for the frames 113 that were determined to be relevant to processing by the machine-learning model 118. The data processing system 102 can execute a frame selector process 106 (sometimes referred to herein as the “frame selector 106”). The frame selector 106 can include hardware, software, or combinations of hardware and software to perform the various functionalities described herein. The frame selector 106 can access the markers 120 generated or otherwise extracted by the decoder 104 to identify selected frames 108 to provide as input to the machine-learning model 118.

In one example, the frame selector 106 can identify all frames 113 generated by the decoder 104 that are associated with a respective marker 120 as one of the selected frames 108. In this example, the selected frames 108 include all frames 113 in the video data 112 for which a marker 120 was generated, as described herein. In another example, the frame selector 106 may implement filtering criteria to reduce the number of frames to be provided as input to the machine-learning model 118. The filtering criteria may include selecting a predetermined number of frames 113 for which markers 120 are generated within discrete windows of time as the selected frames 108. This can limit the number of selected frames 108 provided as input to the machine-learning models, for example, when many frames 113 having markers 120 are decoded within a relatively short time interval.

In another example, the frame selector 106 can select frames 113 as the selected frames 108 if the markers 120 for those frames 113 satisfy one or more selection criteria. In one example, the selection criteria may include, but is not limited to, selecting frames 113 in which particular objects, features, or temporal activity is detected. The selection criteria for the selected frames 108 may be configurable and may be stored as part of one or more configuration settings in memory of the data processing system 102. The configuration settings can be modified in response to operator input to the data processing system 102 or in response to one or more messages received from external computing system(s) (e.g., via the network 119).

Frames 113 identified as the selected frames 108 can be stored in one or more data structures for further processing by the data processing system 102. In some implementations, the frames that are unselected (e.g., frames that are not associated with markers 120, or frames with markers 120 that were not selected according to the filtering conditions described herein) can be discarded. In some implementations, rather than being discarded, the frames 113 generated by the decoder 104 can be used in other processing operations implemented by the data processing system 102 or computing systems in communication with the data processing system 102. In some implementations, data of the selected frames 108 can be stored in chronological order, such that selected frames 108 that are provided as input to the machine-learning model in the order they appear in the video data 112.

The data processing system 102 can execute the machine-learning model 118 using the selected frame(s) 108 as input to generate corresponding output. In some implementations, and as described herein, the machine-learning model 118 can include a VLM, which can receive both text data input and video data input to generate output. It should be understood that, although the following examples are described with reference to a VLM, that any type of machine-learning model that processes video data may be utilized in connection with the techniques described herein.

The data processing system 102 can use one or more tokenizer models and/or embeddings models to convert the input data (e.g., the selected frames 108, any input text data or other media data, etc.) into a format (e.g., numerical representation, etc.) that is compatible with the input layers of the machine-learning model 118. Various techniques can be used to convert the selected frames 108 into video information, including but not limited to an embeddings model and/or embeddings layers of the machine-learning model 118, or embeddings models that convert both the selected frame(s) 108 and additional text/multimedia data into the same embeddings space. Different embeddings spaces may be implemented for different media modalities of the input data, in some implementations. The resulting embeddings, once generated, can be provided as input to the machine-learning model 118 for processing to generate corresponding output data.

The data processing system 102 can execute the machine-learning model 118 by autoregressively generating output tokens and/or embeddings, in some implementations. The data processing system 102 can perform the mathematical operations of each layer of the machine-learning model 118, propagating the results of each layer to the next layer for processing until output is generated at one or more output layers. In an example where text data is generated as output, the machine-learning model 118 can include one or more output layers that generate one or more output distributions of token probabilities (e.g., from an output softmax layer, etc.). The data processing system 102 can use one or more configuration settings to select one or more tokens from the output distribution(s) for inclusion in output response. The data processing system 102 can execute the machine-learning model 118 autoregressively, to model sequences of output tokens corresponding to one or more media modalities, including, video data, image data, audio data, and/or text data. For example, the data processing system 102 can execute the machine-learning model 118 to predict one or more next tokens in an output sequence, which can then be included in the input context for the next iteration, as described herein.

The data processing system 102 can execute the machine-learning model 118 iteratively, incorporating previously generated tokens/embeddings as context for generating subsequent output, until a termination condition has been satisfied. One type of termination condition can be a context length limit or a configurable limit on the number of tokens that can be generated and/or processed by the machine-learning model 118. In some implementations, the termination condition can be satisfied when the machine-learning model 118 generates an output that represents the end of a response. The machine-learning model 118 may be trained/updated to be a conversational agent, in some implementations. For example, the machine-learning model 118 can generate realistic natural language in response to natural language input with video data. In one non-limiting example, the machine-learning model 118 can include a VLM that generates natural language output that summarizes actions/activity that occurs in input video data.

Once the termination condition for executing the machine-learning model 118 has been detected, the data processing system 102 can convert any encoded output generated by the machine-learning model 118 into a decoded format for storage, transmission, or further processing. In some implementations, this can include performing an inverse operation from the embeddings generation/tokenization process used to convert the input data to a format compatible with the machine-learning model 118. Once the output has been converted into a suitable format, the data processing system 102 can perform further processing operations using the converted output. For example, the data processing system 102 can store the output in association with the input for the machine-learning model 118. In another example, the data processing system 102 can transmit the converted output to the capture system 110 as a response to a prompt (e.g., text data with an encoded bitstream 116) provided by the capture system 110.

In some implementations, the selected frames 108 can be used to update the machine-learning model 118. For example, a training/update dataset can be generated using the selected frames 108 generated from an encoded bitstream 116 according to the techniques described herein. For example, the selected frames 108 can be paired with corresponding input text prompt data and expected output data (e.g., ground truth data), which is subsequently used to implement a supervised learning approach to update the parameters of the machine-learning model 118, for example, in an implementation where the machine-learning model 118 is a VLM. Similar techniques may be used to update the parameters of different types of machine-learning models 118, where expected ground truth data is generated for/paired with input sets of selected frames 108 as training/update examples. Any suitable training/update approach may be used to update the parameters of the machine-learning model 118, including but not limited to supervised learning, unsupervised learning, semi-supervised learning, or self-supervised learning, among others. Parameters of the machine-learning model 118 can be updated using a suitable optimization algorithm (e.g., a gradient descent function, Adam optimizer, etc.).

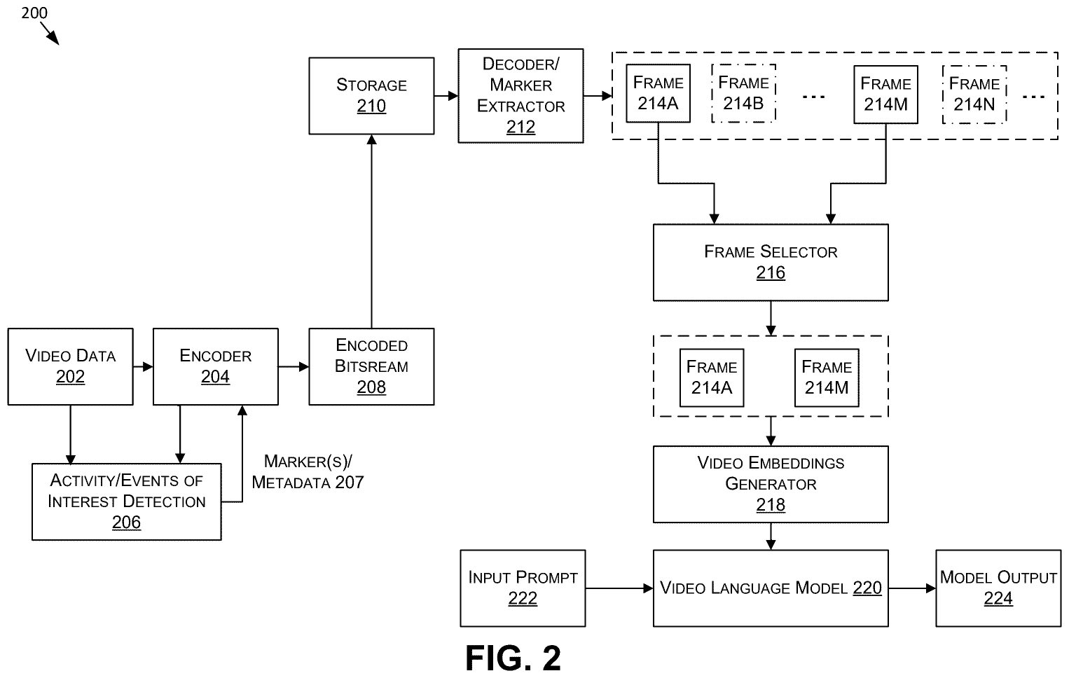

Referring to FIG. 2 in the context of the components described in connection with FIG. 1, illustrated is a dataflow diagram showing how frames are sampled for training/updating machine-learning models, in accordance with some embodiments of the present disclosure. The process 200 shown in the dataflow diagram can be performed, for example, by the capture system 110 and the data processing system 102 of FIG. 1, as described herein. The process 200 provides an example overview of how video data 202 (e.g., the video data 112) can be captured and processed to identify relevant frames for processing using a language model 220 (e.g., the machine-learning model 118). The language model 220 of FIG. 2 is depicted as or including a video language model.

As shown, video data 202 can be processed into an encoded bitstream 208 (e.g., the encoded bitstream 116) using an encoder 204 (e.g., the encoder 114). The encoder 204 may process the video data 202 using a suitable encoding technique, for example, a video codec such as AVC (or h.264), HEVC (or h.265), VVC (or h.266), VP8, VP9, or AV1, or any other video codec standard. Additionally, frames of the video data 202 can be processed using the activity/event of interest detection process 206 (e.g., the marker generator 115). The activity/event of interest detection process 206 can identify frames of the video data 202 that are to be provided as input to the video language model 220, as described in connection with FIG. 1. The activity/event of interest detection process 206 can use information received from the encoder 204 to identify relevant frames, including but not limited to encoder motion vectors, as described herein.

The activity/event of interest detection process 206 can generate markers/metadata 207 (e.g., the markers 120) identifying which frames of the video data 202 are to be provided as input to the video language model 220. The activity/event of interest detection process 206 can process each frame of the video data 202 and can generate markers/metadata 207 only for frames that satisfy one or more conditions, as described herein. The markers/metadata 207 can include any type of indication that a corresponding frame is relevant, and may include a bit, byte, data structure, or SEI information for the encoded bitstream 208. The markers/metadata 207 can be provided to the encoder 204, which can include the markers/metadata 207 in the encoded bitstream 208.

Once generated, the encoded bitstream 208 can be provided to one or more storage systems 210 for subsequent processing. In some implementations, the encoded bitstream 208 can be generated as part of a live video stream and can be provided to a decoder/marker extractor process 212 (e.g., the decoder 104) rather than being provided to a storage system 210. The storage system 210 can be any type of system that can store encoded bitstreams 208 for subsequent processing by the video language model 220. The storage system 210 may be or include the data processing system 102 of FIG. 1, in some implementations. In some implementations, the storage system 210 can be different from and accessible by any system (e.g., the data processing system 102) that executes the video language model 220.

The decoder/marker extractor 212 can generate frames 214A-214N (sometimes referred to as frames 214), which may be similar to the frames 113 of the video data 112 of FIG. 1, from the encoded bitstream 208. In this example, frames 214A and 214M are frames for which one or more marker(s) have been generated, while frames 214B, 214N, and other frames in the sequence (not shown for visual clarity) are not associated with any markers. The frame selector process 216 (similar to, e.g., the frame selector 106 of FIG. 1), can select the frames 214A and 214M to provide as input to the video language model 220, as shown. The frame selector process 216 can select the frames 214A and 214M (e.g., the selected frames 108) according to any of the criteria described herein.

Any frames selected by the frame selector process 216 (in this example, the frames 214A and 214M) are provided as input to a video embeddings generator process 218. The video embeddings generator process 218 can include one or more embeddings models that are trained/updated to convert input frame data into a format (e.g., numerical format, etc,) that is compatible with the input layer(s) of the video language model 220. The video embeddings generator process 218 can generate embeddings for each frame individually or may generate a set of embeddings using a sequence of selected frames, in some implementations.

The output of the video embeddings generator process 218 is provided as input to the video language model 220. In this example, the video language model 220 can receive an input prompt 222 in addition to the frames selected by the frame selector process 216. The input prompt 222 can include any type of multimedia data, such as text data, image data, or audio data, among others. In some implementations, the input prompt 222 can be converted into a format (e.g., numerical format, etc.) that is compatible with one or more input layers of the video language model 220 using a corresponding embeddings/tokenizer model, as described herein.

The video language model 220 can be executed using the input prompt (which may be encoded/tokenized) and the output of the video embeddings generator process 218 to generate the model output 224. The video language model 220 can be trained/updated to generate any type of output, including text data, image data, video data, or audio data, among others. In one example, the video language model 220 can be trained/updated to generate output text data as the model output 224. Furthering this example, the input prompt 222 can include a natural language request to summarize any events that occur in the video data 202. The model output 224, when generated, can include natural language text that summarized any events that are depicted in the video data 202 to respond to the request. The video language model 220 can be implemented as part of a conversational agent, in some implementations.

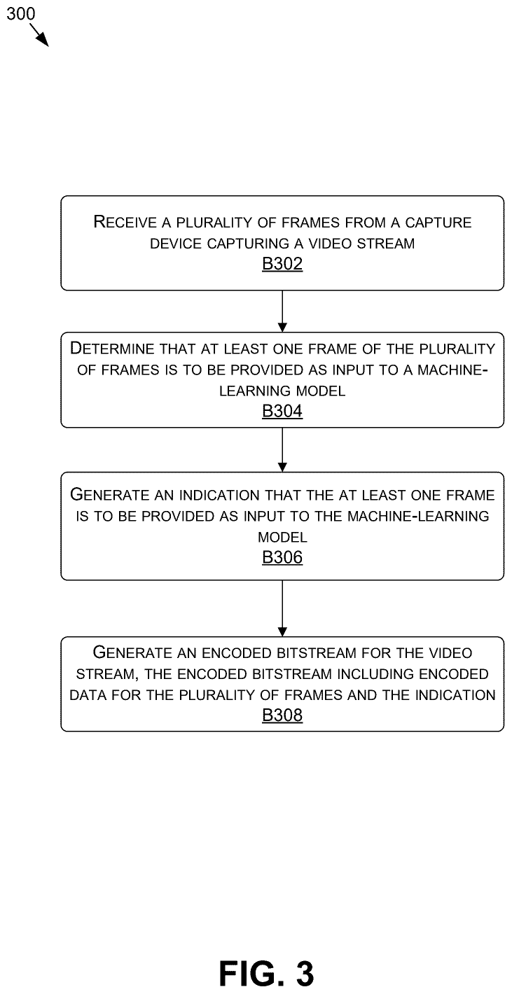

Now referring to FIG. 3, each block of method 300, described herein, includes a computing process that may be performed using any combination of hardware, firmware, and/or software. For instance, various functions may be carried out by one or more processors executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

FIG. 3 is a flow diagram showing a method 300 for implementing video stream generation for generative artificial intelligence systems, in accordance with some embodiments of the present disclosure. The method 300, at block B302, includes receiving a plurality of frames (e.g., the frames 113) from a capture device (e.g., the capture device 111 of the capture system 110) capturing a video stream. In some implementations, the frames of the video stream can be provided by one or more application executing on the capture system. The frames may be received from any suitable capture device, including image or video capture devices. The frames can include any type of image data, including RGB image data or RGB-D image data, in some implementations. The frames can be stored in one or more data structures identifying the order in which the frames are captured.

The method 300, at block B304, includes determining that at least one frame of the plurality of frames is to be provided as input to a machine-learning model (e.g., the machine-learning model 118). To do so, any of the functionality of the marker generator 115 can be implemented. For example, frames can be processed using machine-learning models (e.g., CNN models, RNN models, etc.) to identify the presence of any objects or temporal activity detected in the frames. If a frame indicates an object, feature, or temporal activity that satisfies one or more conditions, as described herein, it can be determined that the frame is to be provided as input to the machine-learning model. If the frame does not satisfy any such conditions, the frame may be determined not to be provided as input to the machine-learning model. Any suitable technique may be used to analyze the frames of the video stream, including but not limited to encoder motion vectors or optical flow motion vectors, as described herein. In some implementations, it can be determined that frames that depict motion that satisfies one or more thresholds are to be provided as input to one or more machine-learning models.

The method 300, at block B306, includes generating an indication (e.g., one or more markers 120) that the at least one frame is to be provided as input to the machine-learning model. The indication may include a tag, marker, data structure, bit, byte, or any type of information that can indicate which frame(s) of the video data are to be provided as input to the machine-learning model. In some implementations, the indication may be generated as part of SEI data, which may be incorporated as part of an encoded bitstream (e.g., the encoded bitstream 116) described in connection with block B308. In some implementations, the indication can be, may include, or may be associated with metadata that indicates the reason the corresponding frame(s) are determined to satisfy condition(s) to be input to the machine-learning model. For example, the indication may identify that the frame depicts motion that satisfies a threshold or may identify that the frame depicts one or more objects or feature(s) of interest, in some implementations.

The method 300, at block B308, includes generating an encoded bitstream (e.g., the encoded bitstream 116) for the video stream (e.g., the video data 112), the encoded bitstream including encoded data for the plurality of frames and the indication (e.g., the marker(s) 120). The encoded bitstream can be generated using any of the techniques described herein, including the techniques described in connection with the encoder 114 of FIG. 1. Generating the encoded bitstream can include encoding the frames of the video stream using a suitable encoding process (e.g., a video codec). Audio data associated with the frames of the video stream may be encoded using similar techniques. Encoded bitstreams generated according to the techniques described herein can include the indication (e.g., marker 120) for each frame that is to be provided as input to the machine-learning model. The indication can be included in the encoded bitstream as a bit, byte, data structure, or SEI data, among others.

Once the encoded bitstream is generated, the encoded bitstream can be stored and/or transmitted to one or more external computing systems (e.g., the data processing system 102) for further processing. In some implementations, the encoded bitstream can be transmitted as part of a real-time streaming protocol, for example, by transmitting encoded frame(s) in the encoded bitstream, with corresponding indications, to the external systems in one or more sequences of network packets. When processing the encoded bitstream, the indications can be extracted and used to select the frames that are to be provided as input to the machine-learning model, as described herein. In some implementations, additional selection criteria can be implemented to reduce the overall computational requirements for processing the frames of the video stream using the machine-learning model.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), light transport simulation (e.g., ray-tracing, path tracing, etc.), collaborative content creation for three-dimensional (3D) assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs), systems for performing light transport simulation, systems for performing collaborative content creation for 3D assets, systems implemented at least partially using cloud computing resources, and/or other types of systems.

### Example Large Language Models

Large language models (LLMs) are a type of generative artificial intelligence (AI) that can understand, summarize, translate, or otherwise generate human-like text based on the context provided in input prompts or queries. These language models are often considered “large” based on their training on massive datasets and having architectures with large number of learnable network parameters (weights and biases), with popular LLMs having millions or billions of parameters. LLMs have become proficient in summarizing textual data, analyzing and extracting insights from data, and generating new text in user-specified styles, tones, or formats. Some LLMs like the early versions of chatbots (e.g., ChatGPT) focus exclusively on text processing, whereas some multimodal LLMs can accept, understand, and/or generate text along with other types of content like images, audio, and/or video. For example, visual language models (VLMs) are a type of LLM that can accept visual and textual input and/or generate visual and textual output.

There are different types of LLM architectures that use different techniques for understanding and generating human-like text. Some early LLM architectures used recurrent neural networks (RNNs) or long short-term memory networks (LSTMs), whereas many modern LLMs use a transformer architecture that relies on self-attention mechanisms to understand and recognize relationships between words or tokens. An LLM may include encoder and/or decoder block(s). Discriminative or encoder-only LLMs like BERT (Bidirectional Encoder Representations from Transformers) are well-suited for tasks that involve language comprehension such as classification, sentiment analysis, question answering, and named entity recognition. Generative or decoder-only LLMs like GPT (Generative Pretrained Transformer) are well-suited for tasks that involve language and content generation such as text completion, story generation, and dialogue generation. LLMs that include both encoder and decoder components like T5 (Text-to-Text Transformer) can understand and generate content, making these models well-suited for tasks such as translation and summarization.

LLMs are primarily trained using unsupervised learning, in which an LLM learns patterns from large amounts of unlabeled text data. Due to their extensive training, LLMs often do not require task-specific or domain-specific training. These types of LLMs that have undergone extensive pre-training on vast amounts of unlabeled text data are often referred to as foundation models and are adept at a variety of tasks like question-answering, summarization, filling in missing information, and translation. Some LLMs may be tailored for a specific use case using techniques like prompt tuning, fine-tuning, and/or adding adapters. As described herein, the various LLMs described herein may be adapted to process sequences of tokens representing video data, audio data, text data, and/or combinations thereof.

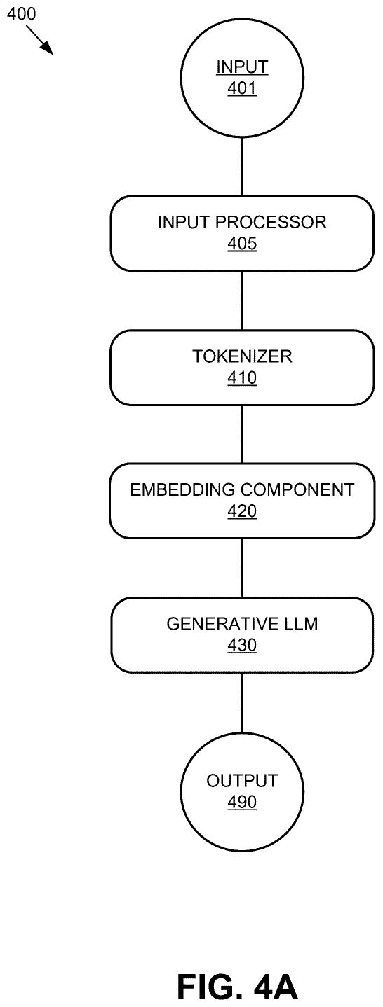

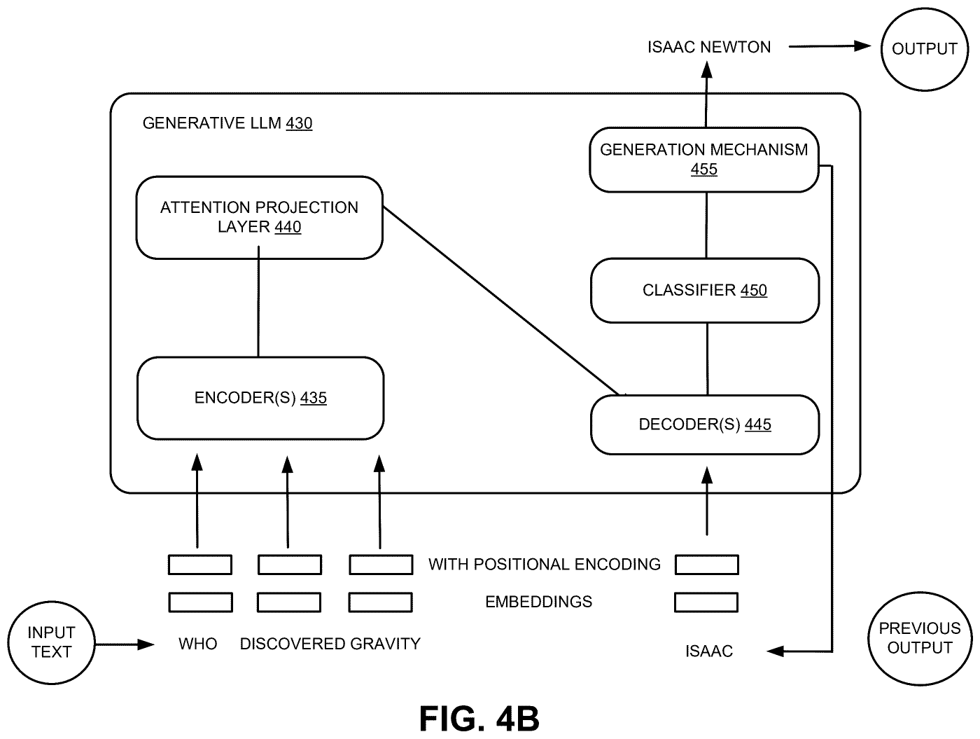

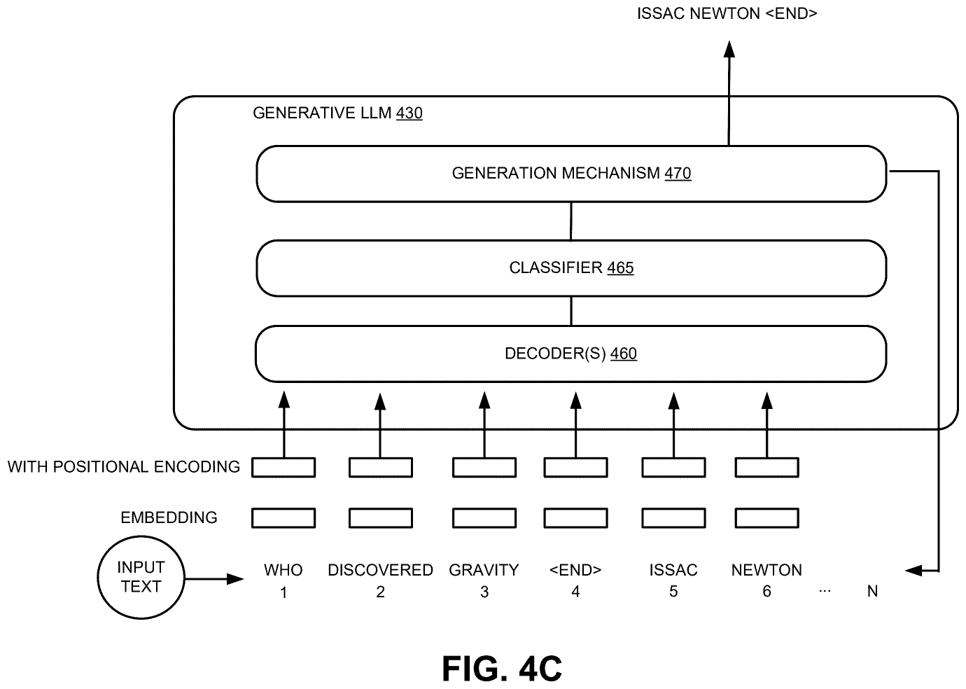

FIG. 4A is a block diagram of an example generative LLM system 400 suitable for use in implementing some embodiments of the present disclosure. In the example illustrated in FIG. 4A, the generative LLM system 400 includes an input processor 405, a tokenizer 410, an embedding component 420, and a generative LLM 430.

At a high level, the input processor 405 may receive an input 401 comprising text and other types of input data, depending on the architecture of the generative LLM 430. Typically, the input 401 includes plain text in the form of one or more sentences, paragraphs, or documents. Additionally or alternatively, the input 401 may include numerical sequences, precomputed embeddings (e.g., word or sentence embeddings), and/or structured data (e.g., in tabular formats, JSON, or XML). In some implementations in which the generative LLM 430 is capable of processing multimodal inputs, the input 401 may combine text with video data, audio data, image data, combinations thereof, and/or other types of input data. Taking raw input text as an example, the input processor 405 may prepare raw input text in various ways. For example, the input processor 405 may perform various types of text cleaning to remove noise (e.g., special characters, punctuation, HTML tags, stopwords) from relevant textual content. In an example involving stopwords (common words that tend to carry little semantic meaning), the input processor 405 may remove stopwords to reduce noise and focus the generative LLM 430 on more meaningful content. The input processor 405 may apply text normalization, for example, by converting all characters to lowercase, removing accents, and/or or handling special cases like contractions or abbreviations to ensure consistency. These are just a few examples, and other types of input processing may be applied.

The tokenizer 410 may segment the (e.g., processed) text into smaller units (tokens) for subsequent analysis and processing. The tokens may represent individual words, subwords, or characters, depending on the implementation. Word-based tokenization divides the text into individual words, treating each word as a separate token. Subword tokenization breaks down words into smaller meaningful units (e.g., prefixes, suffixes, stems), enabling the generative LLM 430 to understand morphological variations and handle out-of-vocabulary words more effectively. Character-based tokenization represents each character as a separate token, enabling the generative LLM 430 to process text at a fine-grained level. The choice of tokenization strategy may depend on factors such as the language being processed, the task at hand, and/or characteristics of the training dataset. As such, the tokenizer 410 may convert the (e.g., processed) text into a structured format.

The embedding component 420 may use any known embedding technique to transform discrete tokens into (e.g., dense, continuous vector) representations of semantic meaning. For example, the embedding component 420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data, the input processor 401 may resize the image data to a standard size compatible with format of a corresponding input channel and/or may normalize pixel values to a common range (e.g., 0 to 1) to ensure a consistent representation, and the embedding component 420 may encode the image data using any known technique (e.g., using one or more convolutional neural networks (CNNs) to extract visual features). In some implementations in which the input 401 includes audio data, the input processor 401 may resample an audio file to a consistent sampling rate for uniform processing, and the embedding component 420 may use any known technique to extract and encode audio features. In some implementations in which the input 401 includes video data, the input processor 401 may extract frames or apply resizing to extracted frames, and the embedding component 420 may extract features such as optical flow embeddings or video embeddings and/or may encode temporal information or sequences of frames. In some implementations in which the input 401 includes multimodal data, the embedding component 420 may fuse representations of the different types of data (e.g., text, image, audio) using techniques like early fusion (concatenation), late fusion (sequential processing), attention-based fusion, etc.

The generative LLM 430 and/or other components of the generative LLM system 400 may use different types of neural network architectures depending on the implementation. Transformer-based architectures such as those used in models like GPT typically include self-attention mechanisms that weigh the importance of different words or tokens in the input sequence and feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 may apply an encoded representation of the input 401 to the generative LLM 430, and the generative LLM 430 may process the encoded representation of the input 401 to generate an output 490, which may include responsive text and/or other types of data.

FIG. 4B is a block diagram of an example implementation in which the generative LLM 430 includes a transformer encoder-decoder. For example, assume input text such as “Who discovered gravity” is tokenized (e.g., by the tokenizer 410 of FIG. 4A) into tokens such as words, and each token is encoded (e.g., by the embedding component 420 of FIG. 94A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 435 of the generative LLM 430.

In an example implementation, the encoder(s) 435 form an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 440 may convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 may generate a first token, and the generation mechanism 455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 may output some decoded (e.g., vector) representation of the input being applied during a particular pass. The classifier 450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 may select or sample a word or token based on a corresponding predicted probability (e.g., select the word with the highest predicted probability) and append it to the output from a previous pass, generating each word or token sequentially. The generation mechanism 455 may repeat the process, triggering successive decoder inputs and corresponding predictions until selecting or sampling a symbol or token that represents the end of the response, at which point, the generation mechanism 455 may output the generated response.

FIG. 4C is a block diagram of an example implementation in which the generative LLM 430 includes a decoder-only transformer architecture. For example, the decoder(s) 460 of FIG. 4C may operate similarly as the decoder(s) 445 of FIG. 4B except each of the decoder(s) 460 of FIG. 4C omits the encoder-decoder self-attention layer (since there is no encoder in this implementation). As such, the decoder(s) 460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 460. As with the decoder(s) 445 of FIG. 4B, each token (e.g., word) may flow through a separate path in the decoder(s) 460, and the decoder(s) 460, a classifier 465, and a generation mechanism 470 may use auto-regression to sequentially generate one token at a time until predicting a symbol or token that represents the end of the response. The classifier 465 and the generation mechanism 470 may operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

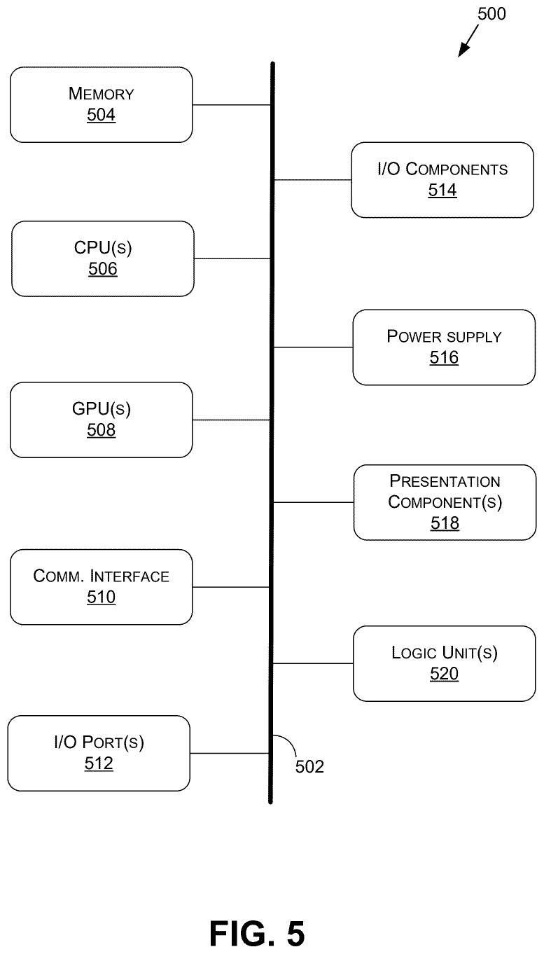

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

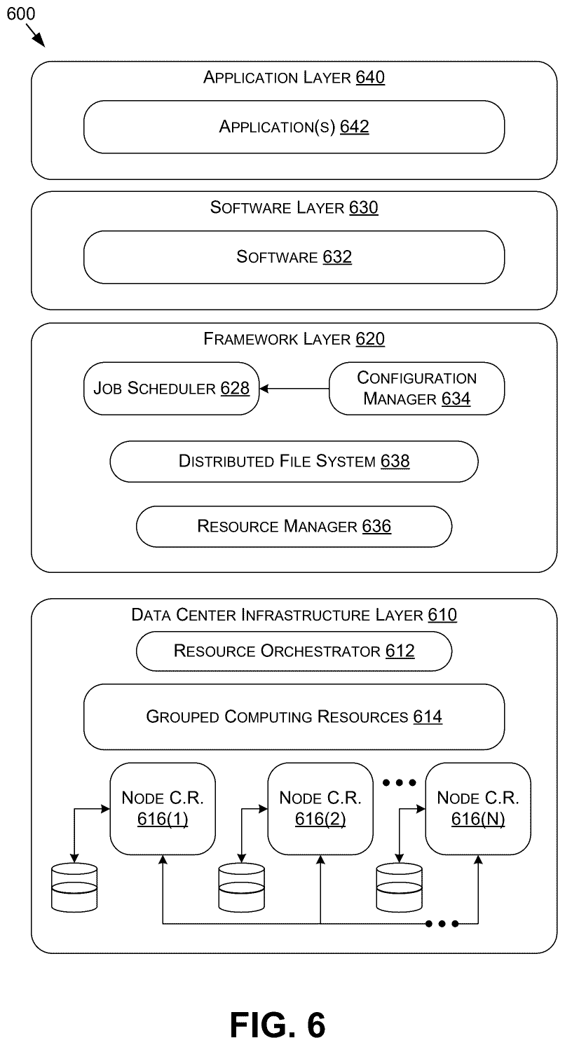

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory, or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may use distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software, or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
receive a plurality of frames from a capture device capturing a video stream;
determine that at least one frame of the plurality of frames is to be provided as input to a machine-learning model;
generate an indication that the at least one frame is to be provided as input to the machine-learning model; and
generate an encoded bitstream for the video stream, the encoded bitstream including encoded data for the plurality of frames and the indication.

2. The one or more processors of claim 1, wherein the one or more circuits are to:
determine that the at least one frame is to be provided as input to the machine-learning model based at least on a motion vector of the at least one frame.

3. The one or more processors of claim 2, wherein the motion vector is generated by an encoding process or an optical flow process.

4. The one or more processors of claim 1, wherein the one or more circuits are to:
determine, using a second machine-learning model, that the at least one frame depicts an object of interest; and
determine that the at least one frame is to be provided as input to the machine-learning model responsive to determining that the at least one frame depicts the object of interest.

5. The one or more processors of claim 1, wherein the one or more circuits are to:
generate the indication to include a binary value indicating that the at least one frame is to be provided as input to the machine-learning model.

6. The one or more processors of claim 1, wherein the one or more circuits are to:
generate the indication to include supplemental enhancement information (SEI) indicating that the at least one frame is to be provided as input to the machine-learning model.

7. The one or more processors of claim 1, wherein the SEI information includes an indication of at least one object detected in the frame.

8. The one or more processors of claim 1, wherein the one or more circuits are to:
transmit the encoded bitstream to a receiver system, causing the receiver system to decode the encoded bitstream and provide the at least one frame as input to the machine-learning model.

9. The one or more processors of claim 8, wherein the one or more circuits are to:
transmit the encoded bitstream according to a real time streaming protocol (RTSP).

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for performing generative AI operations using a video language model (VLM);
a system for generating synthetic data;
a system incorporating one or more virtual machines (VMs);
a system implemented at least partially in a data center; or
a system implemented at least partially using cloud computing resources.

11. A system, comprising:
one or more processors to:
receive an encoded bitstream of a video stream;
decode the encoded bitstream to obtain a plurality of frames and an indication that at least one frame of the plurality of frames is to be provided as input to a machine-learning model; and
provide the at least one frame as input to the machine-learning model according to the indication.

12. The system of claim 1, wherein the one or more processors are to:
retrieve the encoded bitstream of the video stream from a database.

13. The system of claim 1, wherein the one more processors are to:
generate metadata by decoding the encoded bitstream, the metadata comprising the indication that the at least one frame is to be provided as input to the machine-learning model.

14. The system of claim 1, wherein the one or more processors are to:
update the machine-learning model using the at least one frame.

15. The system of claim 1, wherein the machine-learning model comprises a video language model (VLM).

16. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for performing generative AI operations using a video language model (VLM);
a system for generating synthetic data;
a system incorporating one or more virtual machines (VMs);
a system implemented at least partially in a data center; or
a system implemented at least partially using cloud computing resources.

17. A method, comprising:
receiving, using one or more processors, a plurality of frames from a capture device capturing a video stream;
determining, using the one or more processors, that at least one frame of the plurality of frames includes at least one attribute that satisfies one or more thresholds;
in response to the determination, generating, using the one or more processors, an indication for the at least one frame; and
generating, using the one or more processors, an encoded bitstream for the video stream, the encoded bitstream including encoded data for the plurality of frames and the indication.

18. The method of claim 17, wherein the at least one attribute includes at least one of a motion vector detected in the at least one frame, an object detected in the at least one frame, or a temporal activity detected in the at least one frame.

19. The method of claim 18, wherein the motion vector is generated by an encoding process or an optical flow process.

20. The method of claim 17, further comprising:
determining, using the one or more processors, using a second machine-learning model, that the at least one frame depicts an object of interest; and
determining, using the one or more processors, that the at least one frame is to be provided as input to the machine-learning model responsive to determining that the at least one frame depicts the object of interest.
